(19) United States
(12) Patent Application Publication
(10) Pub. No.: US 2015/0191951 A1
(43) Pub. Date: Jul. 9, 2015

(54) LOCKING SYSTEM FOR SLIDING AND PIVOTING DOORS SYSTEMS

(71) Applicants: Francisco Oña-González, Malaga (ES); Javier Lozano-Escudero, Malaga (ES); Jorge Luis Pérez-Falcón, Malaga (ES)

(72) Inventors: Francisco Oña-González, Malaga (ES); Javier Lozano-Escudero, Malaga (ES); Jorge Luis Pérez-Falcón, Malaga (ES)

(73) Assignee: ALLGLASS CONFORT SYSTEM SL., Málaga (ES)

(21) Appl. No.: 14/414,409

(22) PCT Filed: Jul. 12, 2012
(86) PCT No.: PCT/EP2012/002933

§ 371 Date: Jan. 12, 2015

(51) Int. Cl. E05C 21/00; E05D 15/58; E05C 7/00

(52) U.S. Cl. CPC E05C 21/00; E05C 7/00; E05D 15/58

(57) ABSTRACT

Locking system for sliding-pivoting doors/panels (18 and 19) composed of:
A guiding mechanism of the panels (18 and 19) placed in the sliding top track (21) and composed of a cap (8), an array of slots (9) and a guiding inverted “T” which complements the array of slots (9) which can be replaced by a protusion (25) of the top pivot part (24).
A locking and unlocking mechanism of the panels (18 and 19) composed of a “U” shape profile (1) fixed to the wall, “U” shape moving profile (4) a pair of elbow shape parts (2), a handle (3), two blocks (5) and two plates (6) being the width of the base (23) of the profile (1) slightly bigger than the base (22) of the moving profile (4) and fitting the “U” moving profile (4) into the profile (1).

### FIELD OF THE INVENTION

The present invention describes a locking system for sliding-pivoting doors/panels systems which are independent between them. These systems normally are made of aluminium and glass, and are used for delimitation, enclosurements, or isolation of spaces, either in houses (balconies, patios, porches . . . ) or in businesses (restaurants, offices . . . ).

This invention can be included into the technical sector of building systems or materials, in particular, in the sliding-pivoting doors/panels systems which are independent between them.

### STATE OF THE ART

Documents PCT/ES2010/000187 and PCT/ES/2011/00210 describe sliding-pivoting doors/panels systems which are independent between them. All these systems have in common that the pivoting movement is made at one of the sides, wherein a panel works as a normal door. Documents WO2004/011752 A1 and ES2241534T3 show different locking systems. In these systems, when the first panel, normally called door, is blocked, the whole system is blocked too as the rest of the panels fold or pivot at the position of this first panel/door. Else more, the pivoting movement can be done by means of two leverage points, one of them is the top pivot axis and the other one is normally placed at the opposite upper corner of the former point. This second leverage action is done using a part that is perpendicular to the sliding system plane. Documents DE 10333612 (A1) and ES 2262013T3 show systems that include a perpendicular arm as a leverage point.

Each system has its own locking system with a moving opening part and another one that is fixed. The opening part is always placed in the first panel or door. The fix part is always positioned on the top sliding track. There are solutions, as described in document ES 2241534T3, wherein the opening part is based on a cable that enables a top and bottom locker placed on the opposite side to the axis one in the first panel or door. The fix leverage part is perpendicular to the sliding system plane and can be done with different shapes and sizes.

The invention describes a locking system wherein the door locking points are close to the pivoting axis, as a difference with the present ones, whose points are in the opposite side of the pivoting axis. Elsemore, this locking system shifts the upper leverage point, placed in the top corner of each panel, opposite to the top axis, to a point contiguous to the top axis and, moreover, eliminates the top part perpendicular to the sliding system plane that works as a leverage part to enable the pivoting movement for every panel.

The locking system described in this document offers an improvement in the present state of the art as it makes all the panels of the system look the same way and eliminates all vertical opening elements in the first panel or door. Moreover, this locking system is much more resistant to impacts, savotages and extreme weather conditions as strong winds. Finally, improves dramatically the hermeticity of these locking systems as a all the panels are pushed together in a longitudinal way, so there is no gap in between the panels, stopping the water and air coming in.

The leverage system for the pivoting operation of all the panels has some improvements over the state of the art. First of all, eliminates the leverage part that is perpendicular to the sliding system plane and it is made of plastic normally, as shown in document PTC/ES2010/000187. Second, allows the installation of solar protection systems in the indoor side of the system, placed on top of the first panel or door, where the folding or pivoting movement takes place. It is that way, because these solar protection systems are roll operated or just foldable, being fixed onto the ceiling, being its opening movement parallel to the system plane. The existence of the fixed perpendicular part mentioned before, blocks the operation of this rolling or foldable systems as they hit it.

### SUMMARY OF THE INVENTION

The locking system is made of a two set mechanisms described as follows.

The first locking system set works in such a way that a “U” shape aluminium profile is inserted into another “U” shape aluminium profile and has an internal mechanism to operate it. It is possible to modify the distance between the two bases of the “U” shape profiles by means of an external handle. One of the “U” shape profiles is fixed to the wall and the other can move from the other. By means of this movement it is possible to lock or unlock the systems based on independent, sliding and pivoting panels.

The two “U” shape profiles, both fitted and one of them can move inside the other, are placed at the same panel/door side where the pivoting parts are positioned in each panel/door, and they go from the top to the bottom track. All the panels have a unique pivoting axis that is provided and defined by parts, with a half-moon shape, placed inside the top track and are all aligned. Therefore, each pivoting panel has a pivot part on its top corner with a rounded head that enables the pivoting movement as this head matches its predefined half-moon shape part mentioned before. Each panel has a defined position to do its pivoting movement. There are many possible implementations or solutions to achieve this pivoting movement, but the basic mechanics of it are described before. Documents PCT/ES2010/000187 and PCT/ES/2011/000210 show two technical solutions for the pivoting movement.

Locking and unlocking the system is achieved by a slight longitudinal movement of the first panel or door, in such a way that the top pivoting part of the panel doesn't match its corresponding half-moon, it is slightly shifted, resulting in a blocked position for the top rounded head part as it can't rotate or pivot inside its half-moon shape part. As one “U” shape aluminium profile moves inside the other a distance that equals the shift mentioned before, the pivoting movement of the panel is allowed as the top pivot part matches perfectly its corresponding half-moon shape part. Therefore, the system has an open position and a closed position. The closed position implies that the base of the “U” shape profiles are at their furthest possible distance, in the reverse, the open position implies they are at this closest possible distance. The system in the closed position makes the first panel or door to be tightly close to the next panel, and so on with the rest of the panels. The system in the open position generates a gap in between the base of the “U” shape profile furthest from the wall and the glass edge of the first panel or door. This gap is right the shift distance mentioned before that allows the perfect matching of the top pivot part, with a rounded head and fixed inside the top aluminium profile, and the half-moon shape part, fixed inside the top track. By sliding slightly the first panel or door in such a way that this gap disappears, the pivoting movement is allowed, and therefore the panel can be folded. Next panels will work exactly the same way as the distance in between axes for every panel is kept constant and equals the gap distance mentioned before. The first panel/door sliding movement is done with the help of a small knob placed on the surface of its glass.

The approaching and moving away movement in between the two “U” shape profiles is achieved by means of a handle that turns on its axis, as it turns, a vertical movement of two internal long flat plates happens, this vertical movement is parallel to the base of the two “U” shape profiles. Those internal long flat plates are placed along the inside of the interior rectangular hole defined by the two “U” shape profiles, and are both connected in one of their ends to a small plate each, which are part of the internal face of the handle. This vertical movement is converted into a horizontal movement using a 90 degree part, elbow shape, placed on top and bottom of the internal rectangular hole of the locking system. This elbow shape parts are one piece components, with an internal plate with two ends, both out of the elbow shape structure. As the internal plate moves inside, one end goes up-down and the other goes right-left at the same time. The vertical ends of the elbow shape part connect to the internal plates mentioned before by means of a connector, and the horizontal ends connect to two cubic shape parts by means of a connector too. The cubic shape part is fixed to the internal face of the base of the moving “U” profile, so when the cubic part moves it pushes or pulls the moving “U” profile. This way the turning movement of the handle is converted into a horizontal movement of the “U” shape profile and then the first panel or door slides.

The closed position forces the first panel or door to be perfectly matched side by side to the next panel, and so on, this way there is no gap in between the panels and therefore the system is more hermetic against the water and wind. It is frequent that this kind of sliding systems has some disadjustments with the past of the time and the use, so the gap in between the panels can be bigger at some panel joints, this unwanted situation is avoided by this locking system.

The second set of components of this locking system is made of some rectangular shape parts placed inside the top profile of every panel, side by side to each top pivot part. Elsemore, there is an array of slots attached parallel to the top track, in its inner side, in such a way that every rectangular shape part mentioned before passes through a slot, in fact, its corresponding slot, as every panel has a defined position in that array of slots. These slots allow the transversal movement of the panels when the rectangular parts pass through them, but not the longitudinal movement, and therefore, the panel can only move in a transversal way instead of a longitudinal one when doing the pivoting movement. So, there is no need to use a perpendicular part to the sliding system plane as mentioned before to provide a leverage point for every panel when pivoting.

The rectangular shape part that is placed side to side to the top pivot part is designed in such a way that it protrudes from the top profile of the panel. The slot array part does the same from the top track. Both components are placed in such a way that the top protusion of the panel passes through a defined slot when doing the pivoting movement, and by doing so, it avoids any possible longitudinal movement of the panel in relation to the vertical line defined by the top and bottom axis, being possible only the transversal/turning movement in relation to that vertical line. In fact, one part holds the other while the panel is pivoting, as the side of both components are complementary in their shape. By avoiding the longitudinal movement, the panel can not fall during the pivoting operation. This leverage action is achieved at present in these systems using a protruding part perpendicular to the sliding system plane. The result of this improvement is that this perpendicular part can be removed.

The distance in between pivoting axes of every panel is always the same, so every protruding part in the panel and every slot in the top track are predefined and a panel can not be folded passing by the wrong slot.

The first set of components can be removed, using an alternative blocking mechanism made of a rod parallel to the sliding system plane and a blocking pin added to the second set of components. The rod drives a blocking pin in one of the ends of a seesaw which is placed inside the top profile of the first panel or door, when the system is closed, the blocking pin is inside the top track, blocking the opening movement of the panel, as it hits the internal walls of the top track that has a “U” shape. To open the door the rod must be pulled down, so the blocking pin goes down and gets bellow the top track bottom level.

### BRIEF DESCRIPTION OF THE DRAWINGS

FIGS. 1 to 3 show a cross section, side elevation and side view of the first set of components, attached to the wall.

FIG. 4: Elbow shape part of the first set of components.

FIG. 5: Handle of the first set of components.

FIG. 6: Flat plates of the first set of components.

FIG. 7: Fixing block of the first set of components.

FIGS. 8 and 9: “U” shape profiles of the first set of components.

FIG. 10: Slots part of the second set of components.

FIG. 11: Inverted “T” shape part of the second set of components.

FIG. 12: Cap of the second set of components.

FIG. 13: First panel or door.

FIG. 14: Typical sliding and pivoting system with the first panel or door in the open position.

FIG. 15: Typical sliding and pivoting system with the first panel or door in the closed position.

FIG. 16: An alternative configuration of the inverted “T” shape part inserted onto a top pivot part.

FIG. 17: Alternative locking system working without the first set of components and with the second set of components.

### EMBODIMENT EXPLANATION

The locking system for sliding and pivoting panels (18 and 19) is composed of two different mechanisms:

Locking and unlocking mechanism (7) for the sliding of the panels (18 and 19). This mechanism (7) is composed of a set of components placed close to the wall:
a. “U” shape profile (1) fixed to the wall
b. “U” shape moving profile (4) fitted to the “U” shape profile (1) becoming a unique body and it is not attached to the first panel (18)
c. A set of mechanisms (7) of the locking system made of a pair of elbow shape parts (2), a handle (3), two fixing blocks (5) and two plates (6)

Guiding mechanism of the panels (18 and 19), placed in the sliding top track (21) and composed of:

A cap (8) to the exit hole of the sliding top track (21)

An array of slots (9) complementary to the inverted “T” shape part (10)

Inverted “T” shape part (10) that protrudes from the top profile (16).

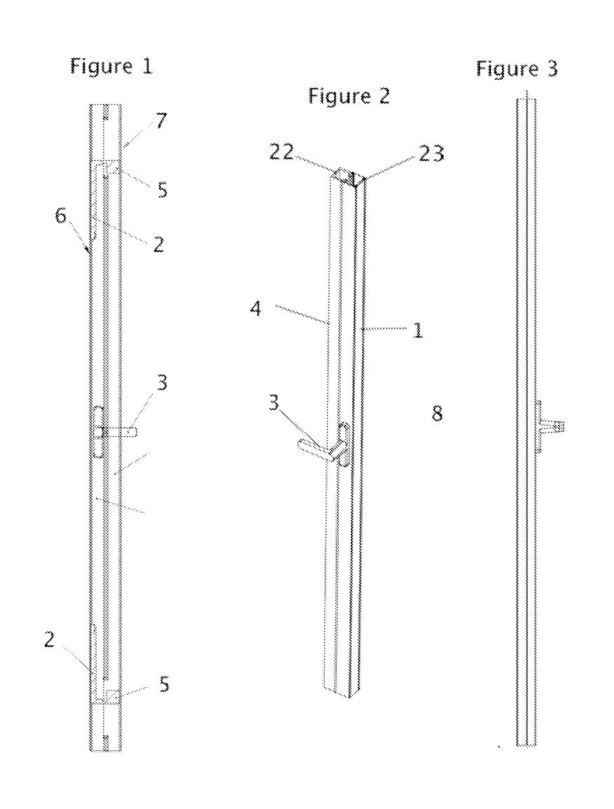

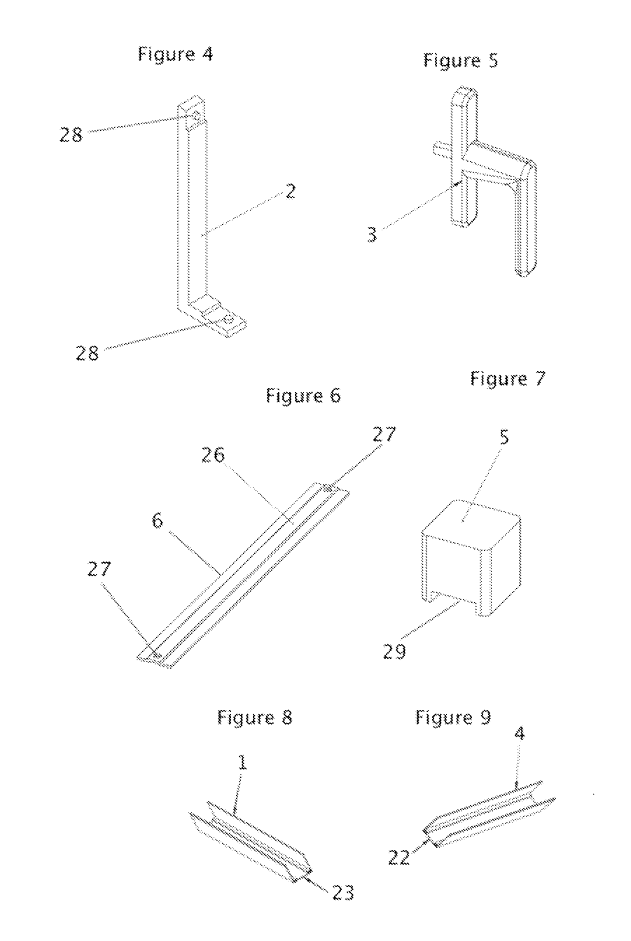

The locking and unlocking mechanism (7) for the sliding of the panels (18 and 19) is shown in FIGS. 1 to 9. The locking and unlocking of the system starts with the operation of the handle (3), which is attached to the fixed “U” shape profile (1). As depicted in FIGS. 1 to 3 the turning movement of the handle (3) is converted into a vertical up-down movement by means of an internal mechanism that connects to the flat plates (6) that move longitudinally up and down along the “U” shape fixed profile (1). The flat plates (6), FIG. 6, have as straight section with a small depression (26) in the middle whose ends have two holes (27) that will be used to connect them to the handle (3) and to the pins in the elbow shape parts (2). Each elbow (2), FIG. 4, has two arms with a rectangular section and dimensions suitable to the section of the “U” shape fixed profile (1). The longest arm connects to the flat plate (6) using a small protuberance (28) or pin that fits into the hole (27) of the flat plate (6). The shortest arm connects, by means of another protuberance (28), to the fixing block (5). So, each elbow has a moving connector at each arm end. The exterior part of the elbow (2) is produced in one single block, inside of it there is a moving plate ending in two moving connectors, in such a way that if one goes down-up, the other goes left-right. These connectors move the same way but in perpendicular directions. This way the elbows (2) convert the vertical movement of the flat plates (6) into another longitudinal-horizontal movement parallel to the floor.

This longitudinal-horizontal movement is transmitted to the moving “U” shape profile (4) by means of two fixing blocks (5). Each block (5), FIG. 7, has a nearly cubic shape, with the corners and edges cuffed and a small recess (29) where the elbow (2) connector is inserted. The opposite side to the elbow (2) of this block (5) is fixed to the base (22) of the moving “U” shape profile (4) in such a way that when the handle (3) turns in the reverse way, the moving “U” shape profile (4) moves in the reverse way driven by the smallest arm connectors of the elbows (2).

As shown in FIG. 8, the base (23) width of the “U” shape profile (1) is slightly bigger than the base (22) of the moving “U” shape profile (4). This way, the base (22) and the moving “U” shape profile (4) can fit into the base (23) and the profile (1) when doing the sliding horizontal movement by means of the internal mechanism described before. Therefore, the “U” shape profiles (1 and 4) fit one into the other in such a way that:

In the open position their bases (22 and 23) are at the closest possible distance.

In the closed position their bases (22 and 23) are at the furthest possible distance.

The distance difference is the size of the gap in between the base (22) of the “U” profile (4) and the vertical line defined by the pivoting axis of the first panel or door (18). This gap equals the distance of the top pivot part of the first panel (18) to its pivoting axis, and as the distance in between axes is constant, is the same distance for the rest of the panels (19) in relation to its corresponding pivoting axis.

Therefore, with the help of the flat plates (6), elbows (2) and fixing blocks (5), the handle (3) can slide longitudinally the door or first panel (18) between the top track (20) and the bottom track (21) and, by doing so, locking and unlocking the system of sliding and pivoting panels (18 and 19).

As shown in FIGS. 11 to 13, when the system is in the open position, the first panel (18) must be moved longitudinally with the help of a knob (17) place on the glass panel until the top pivot part (15) touches the base (22) of the moving “U” shape profile and then can pivot. The rest of the panels (19) pivot the same way, they slide longitudinally until they touch the prior panel (18 or 19) and then reach their pivoting position.

The pivoting movement of the panels (18 and 19) is achieved by means of a half-moon shape parts, not shown in the figures, which are placed in the interior of the top track (21) at the position of the part (9).

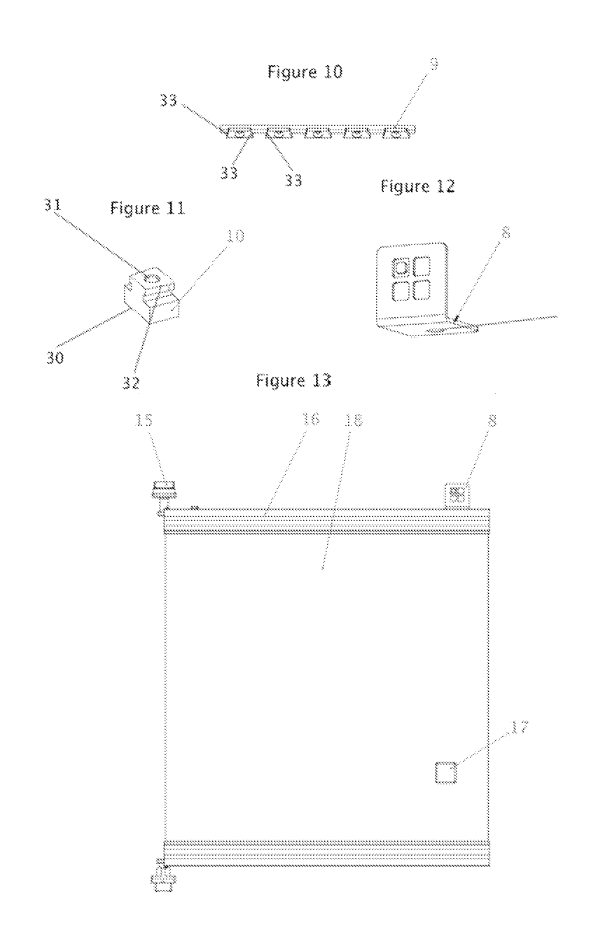

The guiding mechanism of the panels (18 and 19) is depicted in FIGS. 10 to 12. This mechanism is the second set of components of the locking system of this invention and is composed of:

An inverted “T” shape part (10). The base (30) of the T has a bigger section and thickness than the vertical one. The base (30) of the inverted “T” shape (10) in inserted into the top aluminium profile (16) of each panel (18 and 19) and is positioned just side by side to the top pivot element (15) in such a way that the base (30) is completely introduced into the aluminium profile (16). The end part (31) of the vertical part of the T protrudes over the top profile (16) and has a trapezoidal shape with two sides (32) that pass trough its corresponding slot in the array of slots (9). At the top there is a hole for the fixing of the inverted “T” part (10) to the aluminium profile (16).

An array of slots (9) which are complementary to the inverted “T” part (10). As the panel (18 and 19) starts pivoting the upper part (31) of the component (10) passes trough its corresponding slot of the array of slots (9) that is placed in the inner side of the bottom of the top track (21). By doing so, only a transversal movement is allowed to the inverted “T” part (10) that protrudes over the aluminium profile (16). The longitudinal movement of the panels (18 and 19) in relation to the vertical line defined by the pivoting axis is not possible, and they can only move in a circular way around that axis and in a transversal way in relation to the array of slots (9). One of the inner sides of the array of slots (9) becomes a leverage point for every panel (18 and 19) and replaces other state of the art solutions as shown for example in documents PCT/ES2010/000187 and PCT/ES/2011/000210 wherein a protruding part, perpendicular to the sliding system plane, is placed at the same position as the cap (8) in the exit for the panels (18 and 19) of the top track (21). The inner walls (33) of every slot of the array (9), as well as the exterior walls (32) of the end of the vertical part of the inverted “T” (10), are not parallel, this way the same parts (9 and 10) can be used independently of the direction of the opening of the door (18), to the right or to the left.

A cap (8) for covering the exit hole of the top track (21), through this hole pass all the top guiding elements for the panels (18 and 19). Those guiding elements are not shown in the figures. The guiding elements touch the perpendicular leverage part mentioned before to avoid the panel falling when pivoting.

FIG. 13 depicts the first panel or door (18) made of a glass and a top profile (16) and bottom profile. At the top corner, close to the pivoting axis, is placed a pivoting element (15). Close to the opposite top corner the cap (8) is positioned.

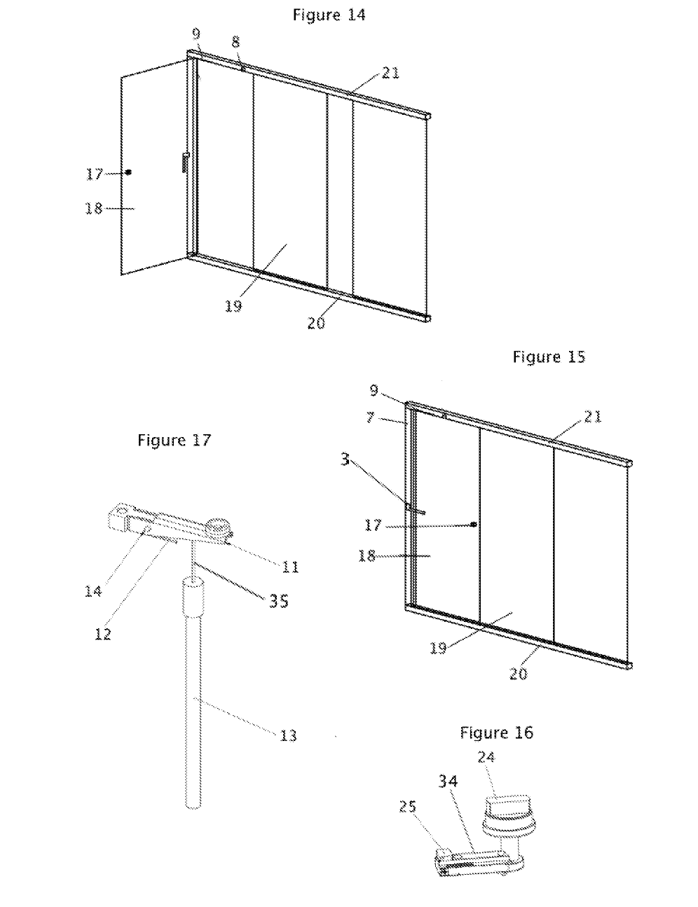

FIGS. 14 and 15 show a enclosurement system based on sliding panels (18 and 19) that are independent and pivoting in its closed and open position. The first panel or door (18) when is in its perpendicular position to the sliding system plane allows the next panels (19) to pivot and be folded. The first set of components of the locking system (7) is placed just by the pivoting axis and the array of slots (9) of the second set of components is located in the indoor part of the system and close to the top pivot axis. All the panels (18 and 19) slide along the tracks (21 and 22).

An alternative configuration for the top pivot element (15) is shown in FIG. 16, wherein the inverted “T” part (10) is replaced by a protusion done at the end of the top level (34) on the arm of the top pivot element (24). By doing so, the top pivot element (15) is merged with the inverted “T” part (10) becoming a new top pivot part (24) wherein the protruding top area (25) is equivalent to the inverted “T” part (10). Therefore, the performance of second set of mechanisms of the locking system is the same with the new part (24) as it is with the former ones (10 and 15).

An alternative way of the locking system, as shown in FIG. 17, uses only the guiding mechanism for the panels (18 and 19), having a cap (8), an array of slots (9) and inverted “T” shape parts (10) or the new top pivot part (24) with a protusion (25). In this case, the locking mechanism for opening and closing the system by sliding the panels (18 y 19), made of two “U” shape profiles (1 and 4) and the mechanisms (7) part of the locking set, which are: two elbows (2), a handle (3), two fixing blocks (5) and two flat plates (6), can be replaced with an alternative locking mechanism. This alternative locking mechanism consists in a rod (13) and a blocking pin part of a seesaw with a spring underneath. The locking operation with this alternative mechanism is composed of a rod (13) that drives a seesaw (11), the seesaw (1) moves up and down, parallel to the sliding system plane, with the help of a spring (12), and is fixed to the aluminium profile (16) by means of a screw and an axis (14). The operation of the parts mentioned before allows the locking and unlocking of the first panel or door (18) as the pin of the seesaw (11) is released from the interior “U” shape hole of the top track (21), as is goes down by pulling down the rod (13). When the rod (13) is released, the pin comes back to its original position, if the door is closed, the pin will lock the system, if the door is opened the pin won't lock the system. When the door is unlocked by this alternative mechanism it can pivot without being slided as it happened with the locking systems based on the movement of two “U” shape profiles described before. This is possible because the door (18) top turning part is always placed in its axis. The next panels (19) will do the pivot movement the same way as describe before, as the distance between axes is the same for all the panels (19).

### NUMBERING OF THE PARTS DESCRIBED

1. Fixed “U” shape profile (1).
2. Elbows (2).
3. Handle (3).
4. Moving “U” shape profile (4).
5. Fixing block (5) part of the first set of mechanisms (7) of the locking system.
6. Flat plate (6) of the first set of mechanisms (7) of the locking system.
7. First set of mechanisms (7) of the locking system made of two elbows (2), a handle (3), two flat plates (6) and two fixing blocks (5).
8. Cap (8).
9. Array of slots (9) for the guiding mechanism for the movement of the panels (18 and 19).
10. Inverted “T” part (10) of the guiding mechanism for the movement of the panels (18 and 19).
11. Seesaw (11) of the alternative locking system.
12. Spring (12) of the alternative locking system.
13. Rod (13) of the alternative locking system.
14. Axis (14) of the alternative locking system.
15. Top pivot part (15) of door and panels (18 and 19).
16. Aluminium profile (16) of the door and panels (18 and 19).
17. Knob (17) of the door (18).
18. Door (18).
19. Panel (19).
20. Top track (20).
21. Bottom track (21).
22. Base (22) of the “U” shape moving profile (4).
23. Base (23) of the “U” shape fixed profile (1).
24. Alternative top pivot part (24) for the top pivot part (15).
25. Protusion (25) of the alternative top pivot part (24).
26. Flat plate (6) depression.
27. Flat plate (6) holes.
28. Elbow (2) connector/pin.
29. Fixing block (5) recess.
30. Base (30) of the inverted “T” part (10).
31. Opposite end (31) of the base (30) of the inverted “T” part (10).
32. Sides of the opposite end (31) of the inverted “T” part (10).
33. Inner walls (33) in the array of slots (9).
34. Top level (34) of the alternative top pivot part (24).

1-5. (canceled)

6. Locking system for sliding-pivoting doors/panels (18 and 19) systems which are independent between them wherein there is a locking and unlocking mechanism based on a sliding operation of the first panel or door (18) and a guiding mechanism of the panels (18 and 19) placed in the sliding top track (21) and comprising:
a cap (8) placed at the exit hole of the sliding top track (21) with a rectangular shape whose base is fixed by means of screws to the interior of the aluminium profile (16) and it is part only of the door (18),
an array of slots (9) placed on the bottom of the top track (21), the slots outstanding from the bottom of the top track (21) and having the slots walls a trapezoidal shape, being the inner walls (33) of the slots not parallel,
a guiding inverted “T” shape part (10) which is fixed in the panels (18 and 19), being the inverted “T” shape part (10) an independent element even of the top pivot part (15) and being the inverted “T” shape part (10) the only support surface of the doors/panels (18,19) when they pivot and having the base (30) of the T a bigger section and thickness than the opposite end (31), being inserted the base (30) of the inverted “T” shape (10) into the top aluminium profile (16) of each panel (18 and 19) and is positioned just side by side to the top pivot element (15), and wherein the end part (31) of the vertical part of the “T”, that outstands from the top profile (16), has a trapezoidal shape with two sides (32) which are complementary and parallel to the inner walls (33) of the slots in the array of slots (9),
working the inverted “T” (10) together with the array of slots (9),
and being the geometry of the inverted “T” shape part (10) and the array of slots (9) asymmetric and complementary between them.

7. Locking system for sliding-pivoting panels (18 and 19) systems which are independent between them with two set of mechanisms according to claim 6 wherein the guiding part for panels (18 and 19) has a protrusion (25), outstanding over the top level (34) of the top pivot part (24), with its outer walls forming a wedge shape and outstands over the top aluminium profile (16) in every panel (18 and 19), being the inverted “T” shape part (10) integral to the top pivot part (15).

8. Locking system for sliding-pivoting doors/panels (18 and 19) systems which are independent between them according to claim 6 wherein the bottom track supports the whole weight of the doors/panels (18 and 19) without any kind of bearings or wheels.

9. Locking system for sliding-pivoting panels (18 and 19) systems which are independent between them according to claim 6 wherein the locking and unlocking mechanism based on a sliding operation of the first panel or door (18) wherein the locking mechanism comprises:
“U” shape profile (1) fixed to the wall,
“U” shape moving profile (4) fitted to the “U” shape profile (1) becoming a unique body,
a set of mechanisms (7) of the locking system made of a pair of elbow shape parts (2), a handle (3), two blocks (5) and two plates (6) which have as straight section with a small depression (26) in the middle whose ends have two holes (27),
wherein interior part of the handle (3) is connected to two flat plates (6), one at the top and the other at the bottom, and wherein the flat plates (6) are placed along and onto the base (23) of the “U” shape profile (1), up to the top and bottom of the “U” shape profile (1) where they are connected to two elbows (2) with two different length arms in 90° angle each, having each elbow (2) two arms with a rectangular section and dimensions suitable to the section of the “U” shape fixed profile (1) in the extreme of each arm a protuberance (28), being the elbows (2) produced in one piece and having inside a moving connector that outstands from the longest arm and is connected to the flat plate (6) by means of a protrusion (28) and a hole (27) in the flat plate (6), and another connector that outstands the shortest arm for the elbow (2) and connects to a fixing block (5) with a nearly cubic shape with the corners and edges cutted and a small recess (29) where the elbow (2) connector is inserted by means of another protuberance (28) and wherein the fixing block (5) is fixed to the base (22) of the “U” shape moving profile (4), moving these connectors in the same way but in perpendicular directions and converting the vertical movement of the flat plates (6) into another longitudinal-horizontal movement parallel to the floor,
being the width of the base (23) of the profile (1) slightly bigger than the base (22) of the moving profile (4) and fitting the “U” moving profile (4) into the profile (1) when the sliding horizontal movement.

10. Locking system for sliding-pivoting panels (18 and 19) systems which are independent between them according to claim 9 wherein:
when the “U” shape profiles (1 and 4) fit one into the other in the open position their bases (22 and 23) are at the closest possible distance,
when the “U” shape profiles (1 and 4) fit one into the other in the closed position their bases (22 and 23) are at the furthest possible distance,
being the distance difference the size of the gap in between the base (22) of the “U” profile (4) and the vertical line defined by the pivoting axis of the first panel or door (18) and being the gap equals to the distance of the top pivot part of the first panel (18) to its pivoting axis,
and being the distance in between axes constant and the same distance for the rest of the panels (19) in relation to its corresponding pivoting axis.

11. Locking system for sliding-pivoting panels (18 and 19) systems which are independent between them according to claim 10 wherein the turning movement of the handle (3) is converted into a vertical up-down movement by means of the internal mechanism described in the previous claim,
wherein the longitudinal-horizontal movement is transmitted to the moving “U” shape profile (4) by means of two fixing blocks (5),
wherein when the handle (3) turns in the reverse way, the moving “U” shape profile (4) moves in the reverse way driven by the smallest arm connectors of the elbows (2) by fixing the opposite side to the elbow (2) of this block (5) to the base (22) of the moving “U” shape profile (4),
and wherein locking and unlocking the system of sliding and pivoting panels (18 and 19) is made sliding longitudinally the door or first panel (18) between the top track (20) and the bottom track (21) and with the help of the flat plates (6), elbows (2) and fixing blocks (5) and the handle (3).

12. Locking system for sliding-pivoting panels (18 and 19) systems which are independent between them according to claim 6 wherein the locking and unlocking of the first panel (18) is done with a rod (13), a steel cable (35) which connects the spring (12) of a seesaw (11) fixed to the aluminium profile (16) of the first panel (18) by means of a screw and an axis (14) and wherein the steel cable (35) passes through the aluminium profile (16).
